(19) United States
(12) Patent Application Publication
(10) Pub. No.: US 2025/0209671 A1
(43) Pub. Date: Jun. 26, 2025

(54) ELECTRONIC DEVICE

(71) Applicant: Panasonic Intellectual Property Management Co., Ltd., Osaka (JP)

(72) Inventor: Kohei YAMAMOTO, Nara (JP)

(73) Assignee: Panasonic Intellectual Property Management Co., Ltd., Osaka (JP)

(21) Appl. No.: 18/971,502

(22) Filed: Dec. 6, 2024

(30) Foreign Application Priority Data
Dec. 20, 2023 (JP) 2023-214949

(51) Int. Cl. G06T 7/90; G06F 3/04845; G06T 11/00; G06T 11/60

(52) U.S. Cl. CPC G06T 7/90; G06F 3/04845; G06T 11/001; G06T 11/60; G06T 2207/10024; G06T 2207/20092

(57) ABSTRACT

An electronic device includes: a communication interface; an input interface configured to receive input of a user operation; a display; and a controller. The controller is configured to: receive, from the server, first color conversion data resulting from compressing original color conversion data at a predetermined first compression ratio; generate second image data by applying the first color conversion data to first image data; cause the display to display a first and second image; and receive second color conversion data or the original color conversion data from the server, based on the user operation received via the input interface after the first image and the second image are displayed, the second color conversion data resulting from compressing the original color conversion data at a second compression ratio lower than the first compression ratio.

### TECHNICAL FIELD

The present disclosure relates to an electronic device that handles data for converting colors of an image, such as a lookup table (LUT).

### BACKGROUND ART

JP 4618803 B2 discloses an object to make image processing parameters downloaded from an external device, settable to an image capturing device, as well as to a photo editing application.

### SUMMARY

The present disclosure provides an electronic device capable of improving usability of color conversion data on a server.

An electronic device according to one aspect of the present disclosure includes:
a communication interface configured to communicate with a server;
an input interface configured to receive input of a user operation;
a display configured to display an image; and
a controller,
   wherein the controller is configured to:
receive, first color conversion data resulting from compressing original color conversion data at a predetermined first compression ratio;
generate second image data by applying the first color conversion data to first image data;
cause the display to display a first image indicated by the first image data and a second image indicated by the second image data; and
receive second color conversion data or the original color conversion data from the server via the communication interface, based on the user operation received via the input interface after the first image and the second image are displayed, the second color conversion data resulting from compressing the original color conversion data at a second compression ratio lower than the first compression ratio.

An electronic device according to another aspect of the present disclosure includes:
a communication interface configured to communicate with a server;
an input interface configured to receive input of a user operation;
a display configured to display an image; and
a controller,
   wherein the controller is configured to:
receive, from the server via the communication interface, first image data, and second image data resulting from applying first color conversion data to the first image data;
generate second color conversion data that converts color information of the first image data into color information of the second image data;
generate fourth image data by applying the second color conversion data to third image data;
cause the display to display an image indicated by the third image data and an image indicated by the fourth image data; and
receive the first color conversion data from the server via the communication interface, based on the user operation received via the input interface after the images are displayed.

With the electronic device according to the present disclosure, usability of color conversion data on the server is improved.

### BRIEF DESCRIPTION OF DRAWINGS

FIG. 1 is a block diagram illustrating an example of a configuration of an LUT management system according to a first embodiment;

FIG. 2 is a block diagram illustrating an example of a configuration of a user terminal according to the first embodiment;

FIG. 3 is a block diagram illustrating an example of a configuration of a server in FIG. 1;

FIG. 4 is a flowchart for explaining an example of a method in which the user terminal according to the first embodiment acquires an LUT;

FIG. 5 is a diagram illustrating an example of an LUT selection screen;

FIG. 6 is a diagram illustrating an example of a comparison screen;

FIG. 7 is a diagram illustrating an example of a sample image selection screen;

FIG. 8 is a diagram illustrating an example of the comparison screen;

FIG. 9 is a diagram illustrating an example of a download progress screen;

FIG. 10 is a diagram illustrating an example of the comparison screen;

FIG. 11 is a flowchart for explaining an example of a method in which a user terminal according to a second embodiment obtains an LUT; and

FIG. 12 is a flowchart illustrating details of the process of obtaining a preview LUT in FIG. 11.

### DETAILED DESCRIPTION

Embodiments will be explained in detail with reference to drawings, as appropriate. However, descriptions in detail more than necessary may be omitted. Note that the accompanying drawings and the following description are provided to facilitate those skilled in the art to fully understand the present disclosure, and the accompanying drawings and the following description are not intended to limit the subject matter defined in the claims in any way.

### 1. FIRST EMBODIMENT

### 1-1. Configuration

### 1-1-1. Hardware Configuration

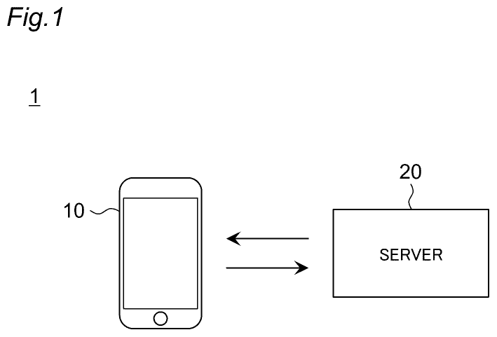

FIG. 1 is a block diagram illustrating an example of a configuration of an LUT management system 1 according to a first embodiment of the present disclosure. The LUT management system 1 includes a user terminal 10 and a server 20. The user terminal 10 is, for example, an electronic device such as a smartphone, a tablet terminal, or a personal computer. The user terminal 10 may also be a digital camera or an electronic device with a camera function. The user terminal 10 and the server 20 are communicably connected via a network, for example.

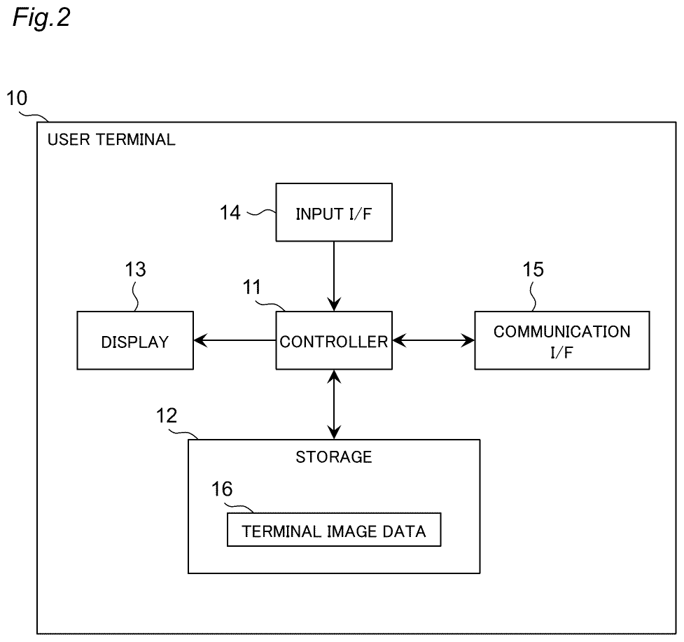

FIG. 2 is a block diagram illustrating an example of a configuration of the user terminal 10. The user terminal 10 includes a controller 11, a storage 12, a display 13, an input interface (I/F) 14, and a communication interface (I/F) 15.

The controller 11 implements functions of the user terminal 10 by performing information processing. Such information processing is implemented by causing the controller 11 to operate in accordance with a program stored in the storage 12, for example. The controller 11 includes an operation circuit that performs operations for the information processing. For example, the controller 11 includes a circuit such as a CPU, an MPU, or an FPGA.

The storage 12 is a recording medium that records various kinds of information including a program required for implementing the functions of the user terminal 10, and terminal image data 16, which will be described later. The storage 12 is implemented by, for example, a semiconductor storage such as a flash memory or a solid state drive (SSD), a magnetic storage such as a hard disk drive (HDD), or another type of a recording medium, alone or in combination. The storage 12 may include a volatile memory such as an SRAM or a DRAM.

The display 13 is a display device capable of displaying information, and examples include a liquid crystal display and an organic EL display.

The input interface 14 is an example of an input unit that connects the user terminal 10 to an input device, such as a touch panel, a touch pad, a keyboard, a mouse, or a pointing device, to input information from the input device to the user terminal 10. For example, the input interface 14 receives a user operation via the input device.

The communication interface 15 is a communication circuit that performs wireless or wired communication, in accordance with a communication protocol. The communication interface 15 is capable of connecting to a network such as an intranet or the Internet, and receiving and transmitting information from and to an external device, such as the server 20. The communication interface 15 may also communicate with an external device directly, without using a network.

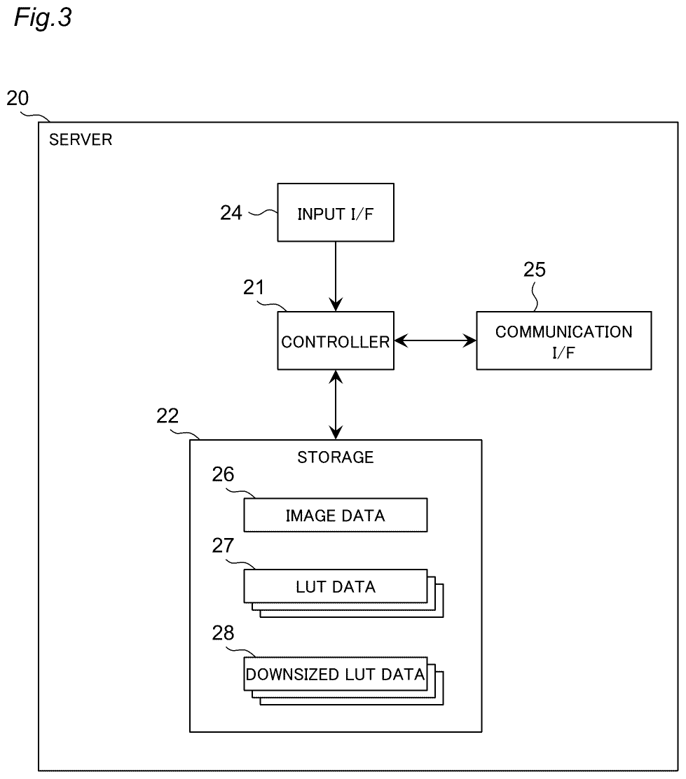

FIG. 3 is a block diagram illustrating an example of a configuration of the server 20. The server 20 includes a controller 21, a storage 22, an input interface 24, and a communication interface 25.

The controller 21 implements functions of the server 20 by operating in accordance with a program stored in the storage 22, for example. The storage 22 is a recording medium for recording various kinds of information including a program required for implementing the functions of the server 20. The storage 22 may store data such as image data 26, one or more LUT data 27, and one or more downsized LUT data 28, which will be described later.

The input interface 24 connects the server 20 to the input device to input information from the input device to the server 20. The communication interface 25 performs wireless or wired communication in accordance with a communication protocol. The controller 21, the storage 22, the input interface 24, and the communication interface 25 may have configurations similar to those of the controller 11, the storage 12, the input interface 14, and the communication interface 15 of the user terminal 10, respectively.

### 1-1-2. LUT

An LUT is an example of color conversion data, and is an array defining a corresponding relationship between color information before and after color information conversion, the color information being color information corresponding to each pixel of an input image. An LUT is, for example, a three-dimensional lookup table indicating a relationship between input color data and output color data that include combinations of RGB three colors. By referring to an LUT, the controller 11 in the user terminal 10 or another image processing apparatus can perform image processing of converting the colors of the input image data into the colors of the output image data.

Each of the one or more LUT data 27 stored in the storage 22 in the server 20 includes an LUT such as that described above. The one or more downsized LUT data 28 include LUTs that correspond to the one or more LUT data 27, respectively.

The LUT data 27 and the downsized LUT data 28 corresponding to the respective LUT data 27 are obtained by, for example, compressing the same original LUT data. For example, the controller 21 in the server 20 generates downsized LUT data 28 by compressing the original LUT data at a first compression ratio, and generates LUT data 27 by compressing the original LUT data at a second compression ratio lower than the first compression ratio. The downsized LUT data 28 therefore has a data size smaller than that of the LUT data 27 corresponding thereto. In this context, the LUT data 27 may be referred to as “low-compression LUT data”, and the downsized LUT data 28 corresponding to the LUT data 27 may be referred to as “high-compression LUT data”.

The controller 21 may also generate a downsized LUT data 28 by compressing the LUT data 27. The downsized LUT data 28 therefore has a data size smaller than that of the LUT data 27 corresponding thereto. In this context, the LUT data 27 may be referred to as “uncompressed LUT data” and the downsized LUT data 28 corresponding to the LUT data 27 may be referred to as “compressed LUT data”.

An example of an LUT compression scheme is downsampling of the lattice points (grid) of the LUT. For example, assuming that a three-dimensional LUT corresponds to an input/output of a ten-bit color space, the color space has 1024 lattice points per dimension. The controller 21 compresses the LUT by downsampling the number of lattice points per dimension, and setting the number of lattice points after downsampling to, for example, 128, 64, 32, or 17. The table thus downsampled is complemented using a known method such as tetrahedron interpolation.

### 1-2. Operation

In the LUT management system 1, the user terminal 10 downloads the downsized LUT data 28 having a relatively smaller data size, before downloading the LUT data 27 having a relatively larger data size, from the server 20. The user terminal 10 causes the display 13 to display an effect to be achieved by applying the downsized LUT data 28 to the image data, to the user. By checking the effect of applying the downsized LUT data 28, the user can indirectly check the effect of the LUT data 27.

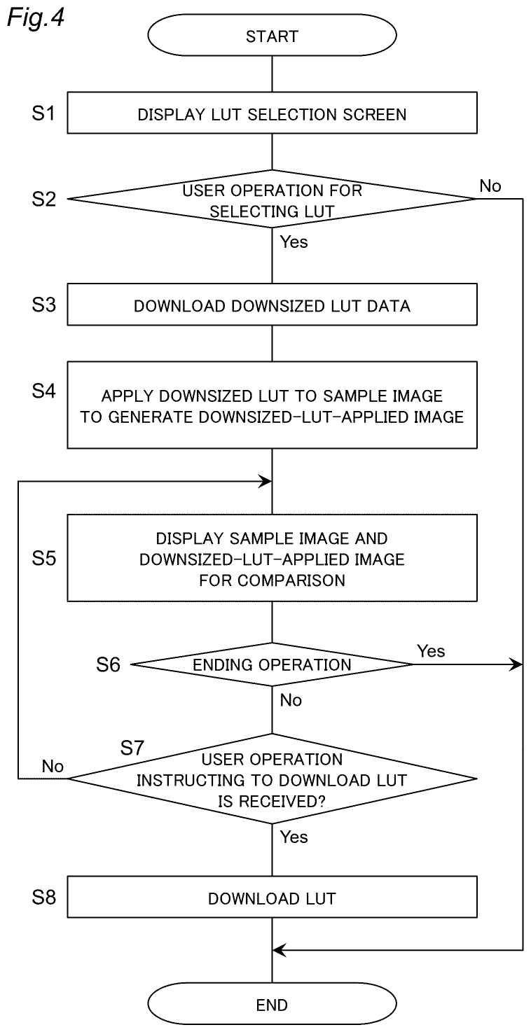

An example of a method in which the user terminal 10 acquires an LUT will now be explained with reference to FIGS. 4 to 10. In the present disclosure, image data is sometimes simply referred to as an “image”.

FIG. 4 is a flowchart for explaining an example of a method in which the user terminal 10 according to this embodiment acquires an LUT. Each step illustrated in the flowchart in FIG. 4 is executed by the controller 11. The process in FIG. 4 starts when the controller 11 receives input of a predetermined user operation via the input interface 14, for example. The user enters the user operation using an input device. Used in the description below is an example in which a touch panel integrated with the user terminal 10 is used as the input device, but the input device is not limited thereto.

To begin with, the controller 11 displays an LUT selection screen on the display 13, in response to a user operation received via the input interface 14 (S1).

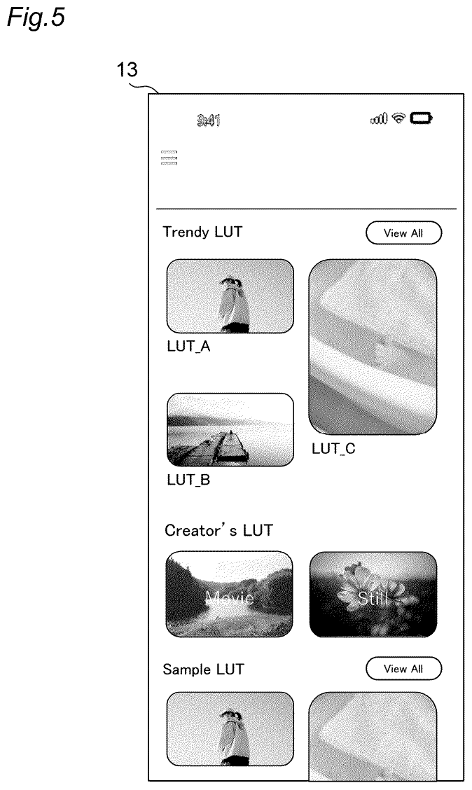

FIG. 5 illustrates an example of the LUT selection screen displayed on the display 13 in step S1 in FIG. 4. The LUT selection screen illustrated in FIG. 5 displays the names of LUT files (“LUT_A”, “LUT_B”, and “LUT_C” in FIG. 5) corresponding to the respective LUT data 27 stored in the storage 22 on the server 20, and thumbnail images to be obtained by applying the respective LUT data 27. In step S1, to display the LUT file names and the thumbnail images corresponding to the respective LUT data 27, the controller 11 in the user terminal 10 acquires information related to the LUT data 27 from the server 20 via the communication interface 15, for example.

Returning to FIG. 4, the controller 11 receives a user operation selecting one of the LUT file names or one of the thumbnail images, such as those described above (S2). For example, upon receiving a user operation selecting one of the LUT file names or one of the thumbnail images on the LUT selection screen illustrated in FIG. 5 (Yes in S2), the controller 11 downloads the downsized LUT data 28 corresponding to the selected LUT data 27 (S3 in FIG. 4).

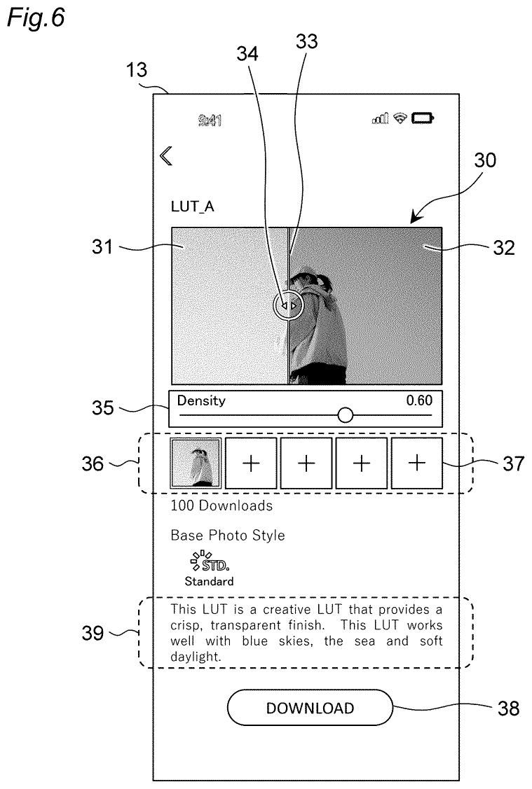

After step S3, the controller 11 causes the screen to transition from the LUT selection screen in FIG. 5 to the comparison screen illustrated in FIG. 6. This transition to the comparison screen may take place between steps S2 and S3, or simultaneously with step S3.

Returning to FIG. 4, the controller 11 applies the downsized LUT data 28 to sample image data, and generates image data applied with the downsized LUT (S4). One example of the sample image data is the image data 26 stored in the storage 22 on the server 20. The controller 11 downloads the image data 26 from the server 20, and applies the downsized LUT data 28 to the image data 26. The sample image data may also be terminal image data 16 stored in the storage 12 of the user terminal 10. The sample image data may be image data acquired by an image capturing device, such as an external digital camera.

The controller 11 then displays a sample image indicated by the sample image data, and a downsized-LUT-applied image indicated by downsized-LUT-applied image data generated in step S4, next to each other for comparison, on the comparison screen in FIG. 6 (S5).

In a comparison section 30 of the comparison screen in FIG. 6, the sample image 31 and the downsized-LUT-applied image 32 are displayed comparatively. In the example illustrated in FIG. 6, the comparison section 30 includes a boundary line 33, and the sample image 31 is displayed on the left side of the boundary line 33, and a downsized-LUT-applied image 32 is displayed on the right side of the boundary line 33. The user can drag a position adjustment button 34 for adjusting the position of the boundary line 33, to move the position of the boundary line 33 to the left or right. By examining the comparison screen described above, the user can check the effect of the downsized LUT data 28, and thus is enabled to check the effect of the LUT data 27 corresponding to the downsized LUT data 28.

The comparison screen illustrated in FIG. 6 presents an introductory text 39 describing LUT data 27 selected in step S2. By reading the introductory text 39, the user can get a grasp of specifics of LUT data 27 that is currently under consideration, such as the effect achieved thereby. The text data indicating the introductory text 39 is stored in the storage 22 on the server 20, in a manner associated with LUT data 27 the introductory text 39 provides an explanation for. Such text data is transmitted to the user terminal 10, together with the downsized LUT data 28 corresponding to LUT data 27, in response to a user operation on the user terminal 10.

The comparison screen illustrated in FIG. 6 also presents a density adjustment menu 35 for adjusting a density at which the downsized LUT is applied to the sample image data. In this embodiment, the density of the LUT is an index indicating the degree by which LUT is applied to the image data, and is represented by a value between 0 and 1 (0% and 100%), for example. Applying the LUT with a zero density set thereto to the input image data is substantially the same as not applying the LUT to the input image data.

The density adjustment menu 35 includes a slide bar for adjusting the density. The user can adjust the density of the downsized LUT by dragging the slide bar, for example. The controller 11 generates composite LUT data indicating a downsized LUT having the density adjusted on the basis of the downsized LUT data 28 and a density parameter specifying the density designated by the user operation, for example. The controller 11 then presents the image resulting from applying the composite LUT in the comparison section 30, by replacing the downsized-LUT-applied image 32 therewith.

The comparison screen in FIG. 6 includes a sample image selection menu 36 from which a sample image 31 to be displayed in the comparison section 30 can be selected. In the example in FIG. 6, the sample image selection menu 36 can display five thumbnail images (preview images) each of which presents a sample image 31. With the sample image selection menu 36, the user can check the effect of the downsized LUT data 28 on various sample images 31 without causing the screen to transition from the comparison screen. As described above, the user terminal 10 according to this embodiment can include a plurality of sample images 31 each of which includes at least one of a different scene or a different subject, in the comparison screen to be presented on the display 13.

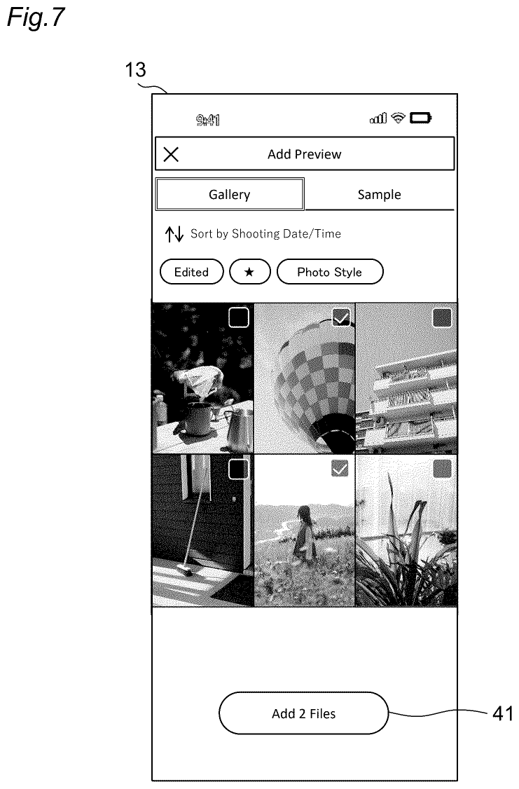

The sample image selection menu 36 in the comparison screen illustrated in FIG. 6 also includes four addition buttons 37 for adding a selectable sample image 31 to the sample image selection menu 36. When the user makes a selection by clicking or tapping on one of the addition buttons 37, the controller 11 causes the screen to transition to a sample image selection screen illustrated in FIG. 7.

The sample image selection screen illustrated in FIG. 7 presents candidate images that are candidates of a sample image 31. One example of the candidate image is an image indicated by the image data 26 stored in the storage 22 on the server 20. The image data 26 is prepared by a plurality of users who can access the server 20, for example. The candidate image may be an image indicated by the terminal image data 16 stored in the storage 12 on the user terminal 10.

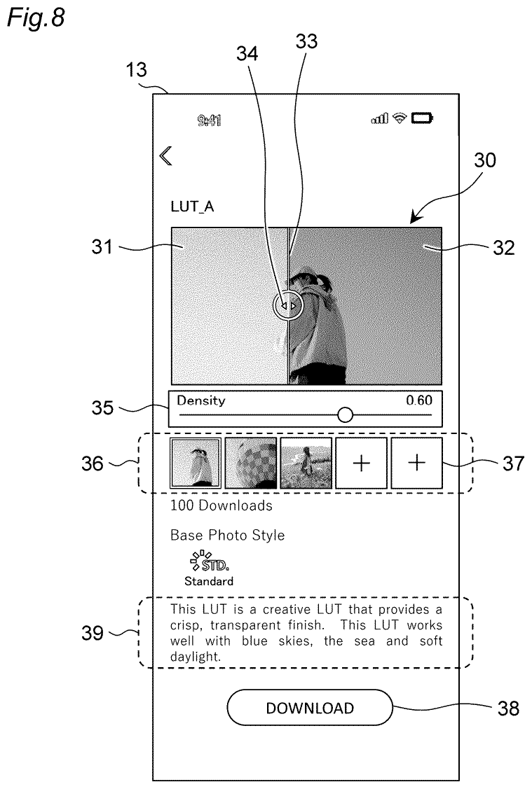

When a user operation of selecting one or more candidate images and clicking or tapping on an addition confirmation button 41 is received, the controller 11 causes the screen to transition to the comparison screen in FIG. 8. As compared with the comparison screen illustrated in FIG. 6, the sample image selection menu 36 of the comparison screen in FIG. 8 includes additional thumbnail images corresponding to the sample images 31 selected by the user on the sample image selection screen illustrated in FIG. 7.

Returning to FIG. 4, when the user makes a user operation (ending operation) of ending the process illustrated in FIG. 4 by making an input on a “return” button, for example, while the comparison screen illustrated in FIG. 6 or 8 is being displayed (Yes in S6), the controller 11 is caused to end the process illustrated in FIG. 4. If the controller 11 does not receive the ending operation, the processing goes to step S7.

In step S7, the controller 11 determines whether input of a user operation instructing to download the LUT data 27 has been received (S7). If input of the user operation instructing to download the LUT data 27 is received (Yes in S7), the controller 11 is caused to download the LUT data 27 (S8).

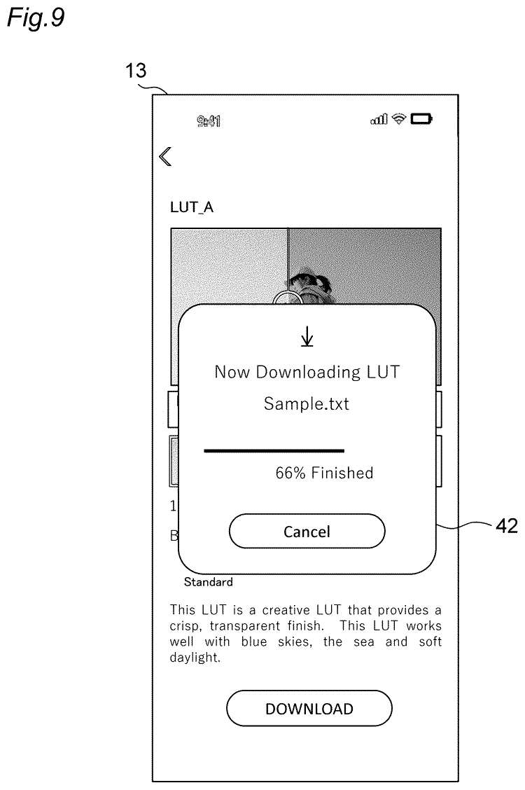

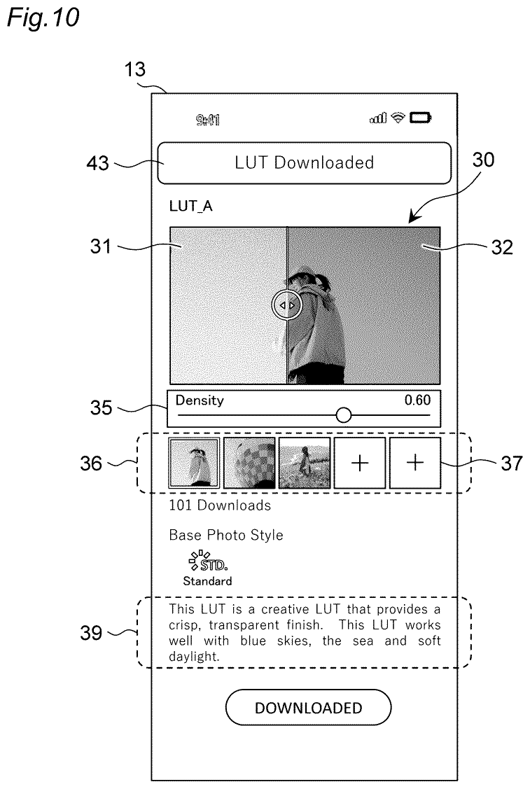

When the user enters a user operation of clicking or tapping on the download button 38 in the comparison screen illustrated in FIGS. 6 and 8 (Yes in S7), the controller 11 is caused to download the LUT data 27 (S8). Once the LUT data 27 starts being downloaded, the controller 11 displays a download progress screen 42 indicating the progress of the download, in a manner superimposed over the comparison screen, for example, as illustrated in FIG. 9. Once the download of the LUT data 27 has completed, the controller 11 displays a text 43 indicating that the download has completed on the comparison screen, for example, as illustrated in FIG. 10.

Returning to FIG. 4, in step S7, if the input of the user operation instructing to download the LUT data 27 is not received (No in S7), the controller 11 returns to step S5.

As described above, with the LUT management system 1 according to this embodiment, the user can check the effect of the LUT data 27 using the downsized LUT data 28 on the user terminal 10 before the LUT data 27 is downloaded in step S8. If, as a result of checking the downsized LUT data 28, the user prefers not to acquire the LUT data 27 corresponding to the downsized LUT data 28, the user can refrain from downloading the LUT data 27 having a relatively larger size. Therefore, the amount of communication on the user terminal 10 can be reduced, as compared with that accrued in downloading the LUT data 27 every time the user is to check for the effect or the like of that LUT data 27. Furthermore, even with a low-speed communication, the user can check the effect of the downsized LUT data 28, and is therefore enabled to substantially check the effect of the LUT data 27.

The user terminal 10 may transmit the LUT data 27 acquired in the manner described above to an image capturing device, such as an external digital camera. Alternatively, the user terminal 10 may store the LUT data 27 in the memory card, to allow the image capturing device to access the LUT data 27 stored in the memory card via an input device such as a card slot. In the manner described above, it is possible to make the LUT data 27 available for use on the image capturing device.

### 1-3. Advantageous Effects or Like

As described above, the user terminal 10, which is an example of an electronic device according to this embodiment, includes the communication interface 15, which is an example of a communication unit configured to communicate with the server 20, the input interface 14, which is an example of an input interface configured to receive input of a user operation, the display 13, which is an example of a display configured to display an image, and the controller 11. The controller 11 receives the downsized LUT data 28 (an example of first color conversion data) resulting from compressing original LUT data (an example of original color conversion data) at a predetermined first compression ratio, from server 20 via the communication interface 15 (S3). The controller 11 generates downsized-LUT-applied image data (an example of second image data) by applying the downsized LUT data 28 to sample image data (an example of first image data) (S4). The controller 11 then causes the display 13 to display a sample image indicated by the sample image data, and a downsized-LUT-applied image indicated by the downsized-LUT-applied image data (S5). The controller 11 receives the LUT data 27 (an example of second color conversion data) resulting from compressing the original LUT data at a second compression ratio lower than the first compression ratio or the original LUT data from the server 20 via the communication interface 15, on the basis of a user operation received via the input interface 14 after the images are displayed (S8).

With the user terminal 10 according to this embodiment, the usability of the LUT data 27 or the original LUT data on the server 20 is improved. For example, the user can check the effect of the downsized LUT data 28 before the LUT data 27 or the original LUT data is received on the user terminal 10. If, as a result of checking the downsized LUT data 28, the user prefers not to acquire the LUT corresponding to the downsized LUT data 28, the user is given a choice to refrain from receiving the LUT data 27 or the original LUT data having a relatively larger size, on the user terminal 10. As a result, the amount of communication on the user terminal 10 can be reduced, compared with a configuration in which the LUT data 27 or the original LUT data is received every time the user is to check for the effect or the like of that LUT data. For example, even with a low speed communication with the server 20, the user terminal 10 can check the effect of the downsized LUT data 28 relatively easily, and is thus enabled to substantially check the effect of the LUT data 27 or the original LUT data.

The user terminal 10 according to this embodiment may further include a storage 12, and the sample image data may be stored in the storage 12 in advance. With this, the user can check the effect of the downsized LUT data 28 using the sample image data before receiving the LUT data 27 or the original LUT data, on the user terminal 10. For example, the user can check the effect of the downsized LUT data 28 by using image data selected by the user, as the sample image data.

The controller 11 may also receive the sample image data from the server 20 via the communication interface 15, and store the received sample image data in the storage 12 in advance. With this, for example, even when the user has no image data at hand, the user can check the effect of the downsized LUT data 28, using the sample image data received from the server 20, before the LUT data 27 or the original LUT data is received on the user terminal 10.

The controller 11 may also cause the display 13 to display a plurality of candidate images each of which is a candidate of the sample image data. When a user enters an operation for selecting one of the plurality of candidate images via the input interface 14, the controller 11 sets candidate image data indicating the selected candidate image as the sample image data. The controller 11 then generates the downsized-LUT-applied image data by applying the downsized LUT data 28 to the sample image data. With this configuration, the user can check the effect of the downsized LUT data 28 on the plurality of candidate images without the need to go through any transition of the screen.

The controller 11 may also receive text data presenting information related to the downsized LUT data 28 to the user, from the server 20 via the communication interface 15. The controller 11 causes the display 13 to display the introductory text 39 indicated by the text data, simultaneously with the sample image and the downsized-LUT-applied image. With this configuration, by reading the introductory text 39, the user can get a grasp of specifics such as effects of the LUT data 27 currently under consideration, for example.

The controller 11 may cause the display 13 to display information indicating a plurality of original LUT data that can be received from the server 20. When a user enters an operation for selecting one of the plurality of original LUT data via the input interface 14, the controller 11 receives the downsized LUT data 28 corresponding to the selected original LUT data from the server 20 via the communication interface 15. With this configuration, the user terminal 10 can give the user a choice to try the effects of the plurality of downsized LUT data 28.

The controller 11 may receive a user operation specifying the density of the downsized LUT data 28 via the input interface 14, and generate the downsized-LUT-applied image data by applying the downsized LUT data 28 to the sample image data in accordance with the density. With this configuration, by specifying the density, the user can check the effect of the downsized LUT data 28 in a broader range, before receiving the LUT data 27 or the original LUT data.

### 2. Second Embodiment

In a second embodiment, the user terminal 10 provides an option, depending on the condition of communication, not to download the downsized LUT data 28 from the server 20 but to generate the downsized LUT on the user terminal 10.

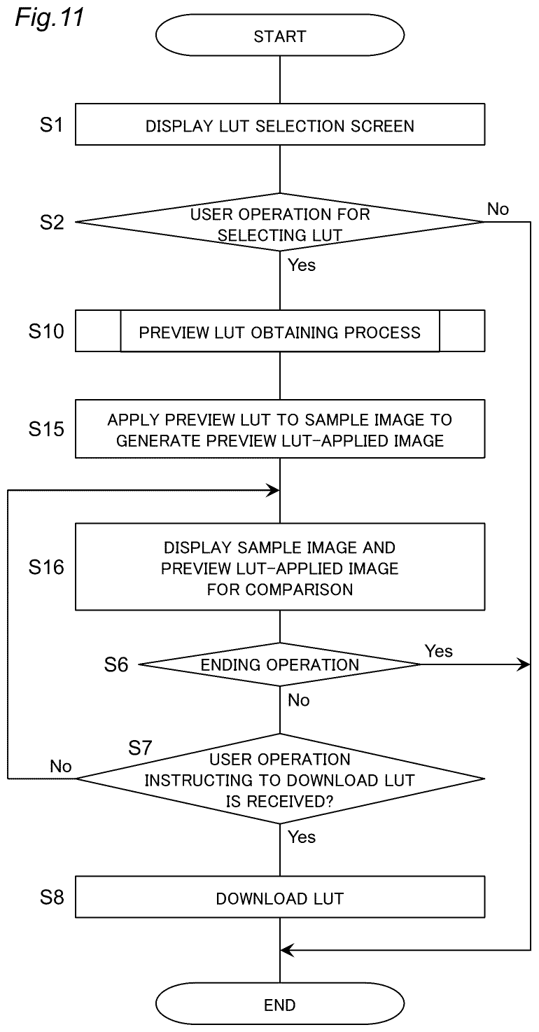

FIG. 11 is a flowchart for explaining an example of a method in which the user terminal 10 according to this embodiment obtains an LUT. As compared with the method for acquiring an LUT according to the first embodiment illustrated in FIG. 4, the method for obtaining an LUT according to this embodiment includes a preview LUT obtaining process S10, instead of step S3 of the first embodiment. In addition, the LUT obtaining method according to this embodiment includes steps S15 and S16, instead of steps S4 and S5 according to the first embodiment.

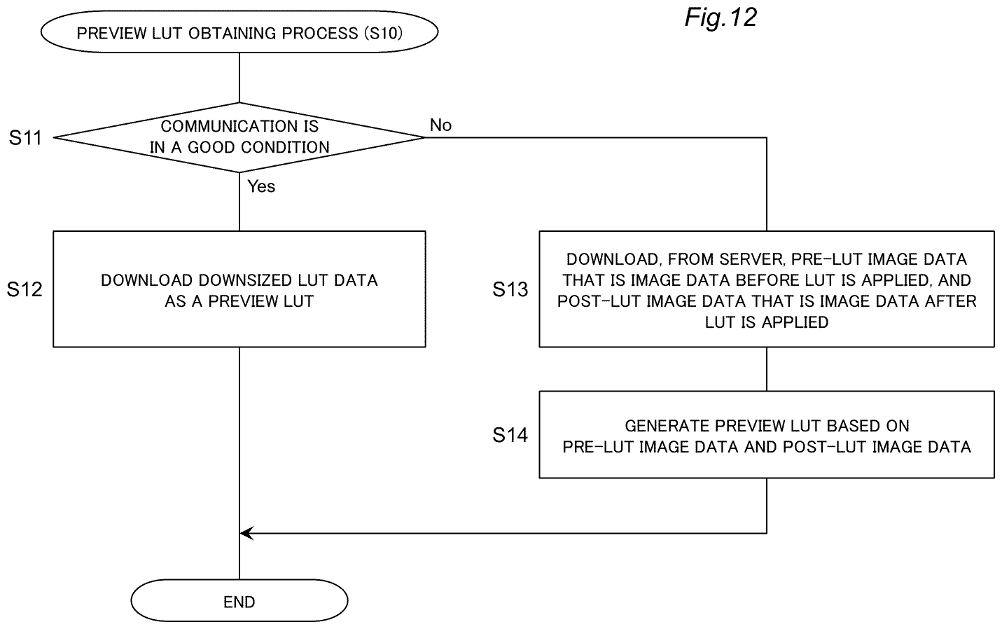

FIG. 12 is a flowchart illustrating details of a process S10 of obtaining a preview LUT in FIG. 11.

In FIG. 12, the controller 11 determines whether the communication with the server 20 is in a good condition (S11). For example, the controller 11 measures the communication speed between the communication interface 15 and the server 20, and determines that the communication with the server 20 is in a good condition when the communication speed is equal to or higher than a predetermined threshold speed.

If it is determined that the communication with server 20 is in a good condition (Yes in S11), the controller 11 downloads the downsized LUT data 28 corresponding to LUT data 27 selected in step S2, from server 20, as a preview LUT (S12).

If the controller 11 determines that the communication with the server 20 is not in the good condition (No in S11), the controller 11 downloads, from the server 20, pre-LUT image data that is image data before the LUT is applied, and post-LUT image data that is image data after the LUT is applied (S13).

The pre-LUT image data is stored in the storage 22 on the server 20, in advance. For example, the pre-LUT image data indicates image data used by the controller 11 of the user terminal 10 only for the purpose of generating a preview LUT. An example of such pre-LUT image data is image data indicating an image including all colors included in a color chart, such as a Macbeth chart. However, the pre-LUT image data is not limited to such image data used only for the purpose of generating the LUT, and may be any image data. For example, the pre-LUT image data may be the image data 26 in FIG. 3.

The post-LUT image data is image data obtained by applying the LUT data 27 to the pre-LUT image data. The LUT data 27 may be applied to the pre-LUT image data by the controller 21 of the server 20 or by a controller of another electronic device.

The controller 11 then generates a preview LUT on the basis of the pre-LUT image data and the post-LUT image data (S14). Using the preview LUT generated in step S14, the color information of the pre-LUT image data can be converted into the color information of the post-LUT image data, for example. The controller 11 generates a preview LUT, for example, on the basis of a result of detecting a difference in color tone between the pre-LUT image data and the post-LUT image data using a color matching technique.

If step S12 or S14 in FIG. 12 is completed, the controller 11 goes to step S15 in FIG. 11.

In step S15, the controller 11 generates preview LUT-applied image data by applying the preview LUT to the sample image data. Step 15 may be a process similar to step S4 in FIG. 4.

In the next step S16, the controller 11 displays the sample image indicated by the sample image data and the preview LUT-applied image data generated in step S15, next to each other for the purpose of comparison, on the comparison screen. Step S16 may be a process similar to step S5 in FIG. 4.

The subsequent processes are the same as those in FIG. 4, and thus description thereof will be omitted.

As described above, the controller 11 included in the user terminal 10 according to this embodiment is enabled to execute the following processing. That is, the controller 11 receives pre-LUT image data (an example of first image data in the embodiment) and post-LUT image data (an example of second image data) resulting from applying the LUT data 27 or the original LUT data (the LUT data 27 and the original LUT data being examples of first color conversion data in this embodiment) to the pre-LUT image data, from the server 20 via the communication interface 15 (S13). The controller 11 then generates a preview LUT (an example of second color conversion data in this embodiment) by which color information of the pre-LUT image data can be converted into color information of the post-LUT image data (S14), and generates preview LUT-applied image data (an example of fifth image data in this embodiment) by applying the preview LUT to the sample image data (an example of third image data in this embodiment) (S15). The controller 11 then causes the display 13 to display a sample image indicated by the sample image data and an image indicated by the preview LUT-applied image data (S16). The controller 11 then receives the LUT data 27 or the original LUT data from the server 20 via the communication interface 15, on the basis of a user operation received via the input interface 14, after the images are displayed (S8).

With the user terminal 10 described above, the controller 11 can generate a preview LUT, without receiving the downsized LUT data 28. Therefore, the user can check the effect of the LUT data 27 or the original LUT data indirectly, by checking the effect of the preview LUT before receiving the LUT data 27 or the original LUT data on the user terminal 10.

In the user terminal 10 according to this embodiment, the controller 11 may determine whether the communication speed between the communication interface 15 and the server 20 is equal to or higher than a predetermined threshold speed (S11). If the communication speed is equal to or higher than the threshold speed, the controller 11 receives the downsized LUT data 28 (an example of third color conversion data) resulting from compressing the original LUT data at a predetermined first compression ratio, from the server 20 via the communication interface 15 (S12). The controller 11 generates preview LUT-applied image data (an example of the fifth image data) by applying the downsized LUT data 28 to the sample image data (S15). The controller 11 causes the display 13 to display the sample image indicated by the sample image data and the image indicated by the preview LUT-applied image data (S16). The controller 11 receives the LUT data 27 (an example of fourth color conversion data) resulting from compressing the original LUT data at a second compression ratio lower than the first compression ratio or the original LUT data from the server 20 via the communication interface 15, on the basis of the user operation received via the input interface 14 after the images are displayed (S8).

With the user terminal 10 according to this embodiment, the usability of the color conversion data on the server 20 is improved. For example, when the communication speed between the communication interface 15 and the server 20 is equal to or higher than a predetermined threshold speed, the user can check the effect of the downsized LUT data 28 before the LUT data 27 or the original LUT data is received on the user terminal 10.

In the user terminal 10 according to this embodiment, if the communication speed is lower than the threshold speed, the controller 11 may execute the processes in steps S13 to S16. The controller 11 receives the LUT data 27 or the original LUT data from the server 20 via the communication interface 15, on the basis of a user operation received via the input interface 14 after the images are displayed in step S16 (S8).

With the user terminal 10 according to this embodiment, if the communication speed is lower than the threshold speed, the controller 11 can generate a preview LUT without receiving the downsized LUT data 28. Therefore, the user can check the effect of the LUT data 27 or the original LUT data indirectly, by checking the effect of the preview LUT before receiving the LUT data 27 or the original LUT data on the user terminal 10.

### 3. Other Embodiments

In the description above, some embodiments have been described as some examples of the technology according to the present disclosure. However, the technology according to the present disclosure is not limited thereto, and may also be applied to embodiments including changes, replacements, additions, omissions, and the like made as appropriate. In addition, it is also possible to combine the elements described in the embodiments to form a new embodiment. Other embodiments will now be explained as some examples.

In the first embodiment, as an example of the LUT, a three-dimensional lookup table indicating the relationship between input and output color data including a combination of three RGB colors has been explained. However, the LUT only needs to be an array (parameter set) defining a corresponding relationship between color information before and after color information conversion, the color information being color information corresponding to each pixel of an input image, and is not limited to a table in which output color has input color data in one-to-one correspondence.

For example, if an LUT has no input color data registered thereto, as input values, the controller 11 may estimate the output color data using a known estimation method, such as tetrahedron interpolation, during image processing for converting the colors in input image data into colors into output image data. Furthermore, the LUT according to the present disclosure is not limited to a three-dimensional lookup table, and may be a lookup table having one or more dimensions.

### 4. Example of Aspects

Hereinafter, various aspects according to the present disclosure will be listed.

Aspect 1 provides an electronic device including:
a communication interface configured to communicate with a server;
an input interface configured to receive input of a user operation;
a display configured to display an image; and
a controller,
   wherein the controller is configured to:
receive, from the server via the communication interface, first color conversion data resulting from compressing original color conversion data at a predetermined first compression ratio;
generate second image data by applying the first color conversion data to first image data;
cause the display to display a first image indicated by the first image data and a second image indicated by the second image data; and
receive second color conversion data or the original color conversion data from the server via the communication interface, based on the user operation received via the input interface after the first image and the second image are displayed, the second color conversion data resulting from compressing the original color conversion data at a second compression ratio lower than the first compression ratio.

Aspect 2 provides the electronic device according to aspect 1, further including a storage, wherein the first image data is stored in advance in the storage.

Aspect 3 provides the electronic device according to aspect 2, wherein the controller is configured to receive the first image data from the server via the communication interface, to store the received first image data in the storage.

Aspect 4 provides the electronic device according to any of the preceding aspects, wherein
the controller is further configured to:
   cause the display to display a plurality of candidate images each of which is a candidate of the first image data;
   in response to input of the user operation selecting one of the plurality of candidate images via the input interface, set candidate image data indicating a selected candidate image, as the first image data; and
   generate the second image data by applying the first color conversion data to the first image data.

Aspect 5 provides the electronic device according to any of the preceding aspects, wherein
the controller is further configured to:
   receive, from the server via the communication interface, text data for presenting information related to the first color conversion data to a user; and
   cause the display to display a text indicated by the text data, simultaneously with the first image and the second image.

Aspect 6 provides the electronic device according to any of the preceding aspects, wherein
the controller is further configured to:
   cause the display to display information indicating a plurality of the original color conversion data receivable from the server; and
   in response to receive the user operation selecting one of the plurality of original color conversion data via the input interface, receive the first color conversion data corresponding to selected original color conversion data, from the server via the communication interface.

Aspect 7 provides the electronic device according to any of the preceding aspects, wherein
the controller is further configured to:
   receive input of the user operation of designating a density of the first color conversion data via the input interface; and
   generate the second image data by applying the first color conversion data to the first image data in accordance with the density.

Aspect 8 provides an electronic device including:
a communication interface configured to communicate with a server;
an input interface configured to receive input of a user operation;
a display configured to display an image; and
a controller,
   wherein the controller is configured to:
receive, from the server via the communication interface, first image data, and second image data resulting from applying first color conversion data to the first image data;
generate second color conversion data that converts color information of the first image data into color information of the second image data;
generate fourth image data by applying the second color conversion data to third image data;
cause the display to display an image indicated by the third image data and an image indicated by the fourth image data; and
receive the first color conversion data from the server via the communication interface, based on the user operation received via the input interface after the images are displayed.

Aspect 9 provides the electronic device according to aspect 8, wherein
the controller is further configured to determine whether a communication speed between the communication interface and the server is equal to or higher than a predetermined threshold speed, and
when the communication speed is equal to or higher than the threshold speed, the controller is configured to:
   receive third color conversion data resulting from compressing original color conversion data at a predetermined first compression ratio from the server via the communication interface;
   generate fifth image data by applying the third color conversion data to the third image data;
   cause the display to display an image indicated by the third image data and an image indicated by the fifth image data; and
   receive fourth color conversion data or the original color conversion data from the server via the communication interface, based on the user operation received via the input interface after the images are displayed, the fourth color conversion data resulting from compressing the original color conversion data at a second compression ratio lower than the first compression ratio.

Aspect 10 provides the electronic device according to aspect 8, wherein
the controller is further configured to determine whether a communication speed between the communication interface and the server is equal to or higher than a predetermined threshold speed, and
when the communication speed is lower than the threshold speed, the controller is configured to:
   receive the first image data and the second image data from the server via the communication interface;
   generate the second color conversion data;
   generate the fourth image data by applying the second color conversion data to the third image data;
   cause the display to display an image indicated by the third image data and an image indicated by the fourth image data; and
   receive the first color conversion data from the server via the communication interface, based on the user operation received via the input interface after the images are displayed.

Aspect 11 provides the electronic device according to aspect 9, wherein
when the communication speed is lower than the threshold speed, the controller is configured to:
   receive the first image data and the second image data from the server via the communication interface;
   generate the second color conversion data;
   generate the fourth image data by applying the second color conversion data to the third image data;
   cause the display to display an image indicated by the third image data and an image indicated by the fourth image data; and
   receive the first color conversion data from the server via the communication interface, based on the user operation received via the input interface after the images are displayed.

The present disclosure is applicable to various electronic devices.

What is claimed is:

1. An electronic device comprising:
a communication interface configured to communicate with a server;
an input interface configured to receive input of a user operation;
a display configured to display an image; and
a controller,
wherein the controller is configured to:
receive, from the server via the communication interface, first color conversion data resulting from compressing original color conversion data at a predetermined first compression ratio;
generate second image data by applying the first color conversion data to first image data;
cause the display to display a first image indicated by the first image data and a second image indicated by the second image data; and
receive second color conversion data or the original color conversion data from the server via the communication interface, based on the user operation received via the input interface after the first image and the second image are displayed, the second color conversion data resulting from compressing the original color conversion data at a second compression ratio lower than the first compression ratio.

2. The electronic device according to claim 1, further comprising a storage, wherein the first image data is stored in advance in the storage.

3. The electronic device according to claim 2, wherein the controller is configured to receive the first image data from the server via the communication interface, to store the received first image data in the storage.

4. The electronic device according to claim 1, wherein
the controller is further configured to:
cause the display to display a plurality of candidate images each of which is a candidate of the first image data;
in response to input of the user operation selecting one of the plurality of candidate images via the input interface, set candidate image data indicating a selected candidate image, as the first image data; and
generate the second image data by applying the first color conversion data to the first image data.

5. The electronic device according to claim 1, wherein
the controller is further configured to:
receive, from the server via the communication interface, text data for presenting information on the first color conversion data to a user; and
cause the display to display a text indicated by the text data, simultaneously with the first image and the second image.

6. The electronic device according to claim 1, wherein
the controller is further configured to:
cause the display to display information indicating a plurality of the original color conversion data receivable from the server; and
in response to receive the user operation selecting one of the plurality of original color conversion data via the input interface, receive the first color conversion data corresponding to selected original color conversion data, from the server via the communication interface.

7. The electronic device according to claim 1, wherein
the controller is further configured to:
receive input of the user operation of designating a density of the first color conversion data via the input interface; and
generate the second image data by applying the first color conversion data to the first image data in accordance with the density.

8. An electronic device comprising:
a communication interface configured to communicate with a server;
an input interface configured to receive input of a user operation;
a display configured to display an image; and
a controller,
wherein the controller is configured to:
receive, from the server via the communication interface, first image data, and second image data resulting from applying first color conversion data to the first image data;
generate second color conversion data that converts color information of the first image data into color information of the second image data;
generate fourth image data by applying the second color conversion data to third image data;
cause the display to display an image indicated by the third image data and an image indicated by the fourth image data; and
receive the first color conversion data from the server via the communication interface, based on the user operation received via the input interface after the images are displayed.

9. The electronic device according to claim 8, wherein
the controller is further configured to determine whether a communication speed between the communication interface and the server is equal to or higher than a predetermined threshold speed; and
wherein the controller is further configured to:
when the communication speed is equal to or higher than the threshold speed,
receive third color conversion data resulting from compressing original color conversion data at a predetermined first compression ratio from the server via the communication interface;
generate fifth image data by applying the third color conversion data to the third image data;
cause the display to display an image indicated by the third image data and an image indicated by the fifth image data; and
receive fourth color conversion data or the original color conversion data from the server via the communication interface, based on the user operation received via the input interface after the images are displayed, the fourth color conversion data resulting from compressing the original color conversion data at a second compression ratio lower than the first compression ratio.

10. The electronic device according to claim 8, wherein
the controller is further configured to determine whether a communication speed between the communication interface and the server is equal to or higher than a predetermined threshold speed, and
wherein the controller is further configured to:
when the communication speed is lower than the threshold speed,
receive the first image data and the second image data from the server via the communication interface;
generate the second color conversion data;
generate the fourth image data by applying the second color conversion data to the third image data;
cause the display to display an image indicated by the third image data and an image indicated by the fourth image data; and
receive the first color conversion data from the server via the communication interface, based on the user operation received via the input interface after the images are displayed.

11. The electronic device according to claim 9, wherein
wherein the controller is further configured to:
when the communication speed is lower than the threshold speed,
receive the first image data and the second image data from the server via the communication interface;
generate the second color conversion data;
generate the fourth image data by applying the second color conversion data to the third image data;
cause the display to display an image indicated by the third image data and an image indicated by the fourth image data; and
receive the first color conversion data from the server via the communication interface, based on the user operation received via the input interface after the images are displayed.
